(19) United States
(12) Patent Application Publication
(10) Pub. No.: US 2005/0046914 A1
(43) Pub. Date: Mar. 3, 2005

(54) Wavelength tuning an external cavity laser without mechanical motion

(76) Inventor: Russell W. Gruhlke, Fort Collins, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/651,677

(22) Filed: Aug. 29, 2003

(51) Int. Cl. H01S 3/115

(52) U.S. Cl. 359/1; 372/12

(57) ABSTRACT

A method of tunable wavelength filtering without requiring mechanical motion is provided. The method comprises receiving a light beam of wavelength within a range of wavelengths, dispersing the light beam at a wavelength-dependent angle, and propagating the light beam through an electro-optic device including an electrically-variable refractive index electro-optic element. The method further comprises applying a control voltage to the electro-optic device, causing tunable wavelength filtering dependent on the control voltage.

### CROSS-REFERENCES TO RELATED APPLICATIONS

This application is related to concurrently filed, co-pending and commonly assigned U.S. patent application Ser. No. ______ [Attorney Docket 10030129-1], titled “EXTERNAL CAVITY LASER IN WHICH DIFFRACTIVE FOCUSING IS CONFINED TO A PERIPHERAL PORTION OF A DIFFRACTIVE FOCUSING ELEMENT”; concurrently filed, co-pending and commonly assigned U.S. patent application Ser. No. ______ [Attorney Docket 10030130-1], titled “USING RELAY LENS TO ENHANCE OPTICAL PERFORMANCE OF AN EXTERNAL CAVITY LASER”; concurrently filed, co-pending and commonly assigned U.S. patent application Ser. No. ______ [Attorney Docket 10030131-1], titled “METHOD OF ENHANCING WAVELENGTH TUNING PERFORMANCE IN AN EXTERNAL CAVITY LASER”; and co-pending and commonly assigned European Patent Application No. 02 017 446.2, titled “WAVELENGTH TUNABLE LASER WITH DIFFRACTIVE OPTICAL ELEMENT,” filed Aug. 3, 2002, the disclosures of all of which are hereby incorporated herein by reference.

### TECHNICAL FIELD

The invention relates to light wavelength filtering and particularly to wavelength tuning an external cavity laser without mechanical motion.

### BACKGROUND OF THE INVENTION

An important property of external cavity lasers is wavelength tuning. To accomplish this, one or more optical components in the external cavity, such as a grating, focusing element or mirror, are typically translated or rotated. This motion causes the cavity to resonate at another wavelength. Unfortunately, this tuning mechanism suffers from the limitations inherent with motor-driven mechanical motion. Motor-generated heat can change the cavity optical path length via the thermal expansion or contraction of materials. This affects the cavity optical properties in an unpredictable manner. The resolution of mechanical wavelength tuning may also be limited by unreproducible mechanical motion and backlash always present in mechanical systems. Motors can also be bulky or, if miniaturized, expensive.

### BRIEF SUMMARY OF THE INVENTION

In accordance with one embodiment provided herein, a method of tunable wavelength filtering without requiring mechanical motion is provided. The method comprises receiving a light beam of wavelength within a range of wavelengths, dispersing the light beam at a wavelength-dependent angle, and propagating the light beam through an electro-optic device including an electrically-variable refractive index electro-optic element. The method further comprises applying a control voltage to the electro-optic device, causing tunable wavelength filtering dependent on the control voltage.

In accordance with another embodiment, an optical system is provided, comprising a dispersing element operable to disperse a light beam at a wavelength-dependent angle, and a variable-index electro-optic device positioned in the path of the light beam. The variable-index electro-optic device includes a variable-index electro-optic element having an electrically-variable refractive index, such that the variable-index electro-optic element is operable to perform wavelength-selective filtering of the light beam, dependent on the value of an applied control voltage.

In accordance with some embodiments, a system and method are provided which use electro-optic materials, e.g., liquid crystals, to accomplish wavelength tuning of an external cavity laser. In particular, wavelength tuning is accomplished by applying a control voltage to the electro-optic material, not by mechanical motion. Hence, the drawbacks inherent with mechanical tuning are avoided.

In accordance with some embodiments, in an external cavity laser, an optical gain medium, for example a light-emitting diode, emits a light beam within a range of wavelengths. The light beam is spectrally dispersed, for example, using a diffraction grating, and propagates through an electro-optic element located in the external cavity. The electro-optic element, for example, comprises a liquid crystal or other electro-optic material having an electrically variable refractive index. In some embodiments, the effective optical path length is tuned in response to an applied control voltage, such that the mode number of the cavity is electrically tuned. Additionally or alternatively to the above, an applied control voltage tunes the critical angle for total internal reflection, such that the desired oscillating wavelength is totally internally reflected and undesired wavelengths are partially segregated from the desired wavelength. In some implementations, a pair of such variable index electro-optic elements is located in the cavity, such that the first element partially segregates longer wavelengths and the second element partially segregates shorter wavelengths relative from the desired wavelength. Control voltages can be the same or determined independently, for example in response to feedback control signals. Numerical analysis shows that sufficient wavelength discrimination is provided to confine laser oscillation to one electrically tunable resonant wavelength.

### BRIEF DESCRIPTION OF THE DRAWINGS

For a more complete understanding of the present invention, reference is now made to the following descriptions taken in conjunction with the accompanying drawings, in which:

FIG. 1 depicts an external cavity laser including optical gain medium, collimating element, dispersing element, two variable index electro-optic elements, and a retro-reflector;

FIG. 2 depicts an external cavity laser in a further embodiment of the present invention, incorporating an additional variable index electro-optic element, which is used to adjust the effective optical path length of light propagating within the external cavity laser;

FIG. 3 depicts wavelength selective total internal optical reflection complementary with partial refraction of a light beam at an interface between a liquid crystal layer and a lower index optical medium contained in a layered structure of a variable index electro-optic element;

FIG. 4A is a graph showing simulated long wavelength pass and short wavelength pass filter characteristics of a liquid crystal embodiment;

FIG. 4B is a graph showing the simulated behavior of a long wavelength pass and a short wavelength pass filter combined to provide a bandpass wavelength filter centered on 1.550 μm; and

FIG. 5 depicts an external cavity laser, including an optical relay element between the optical gain medium and a collimating element.

### DETAILED DESCRIPTION OF THE INVENTION

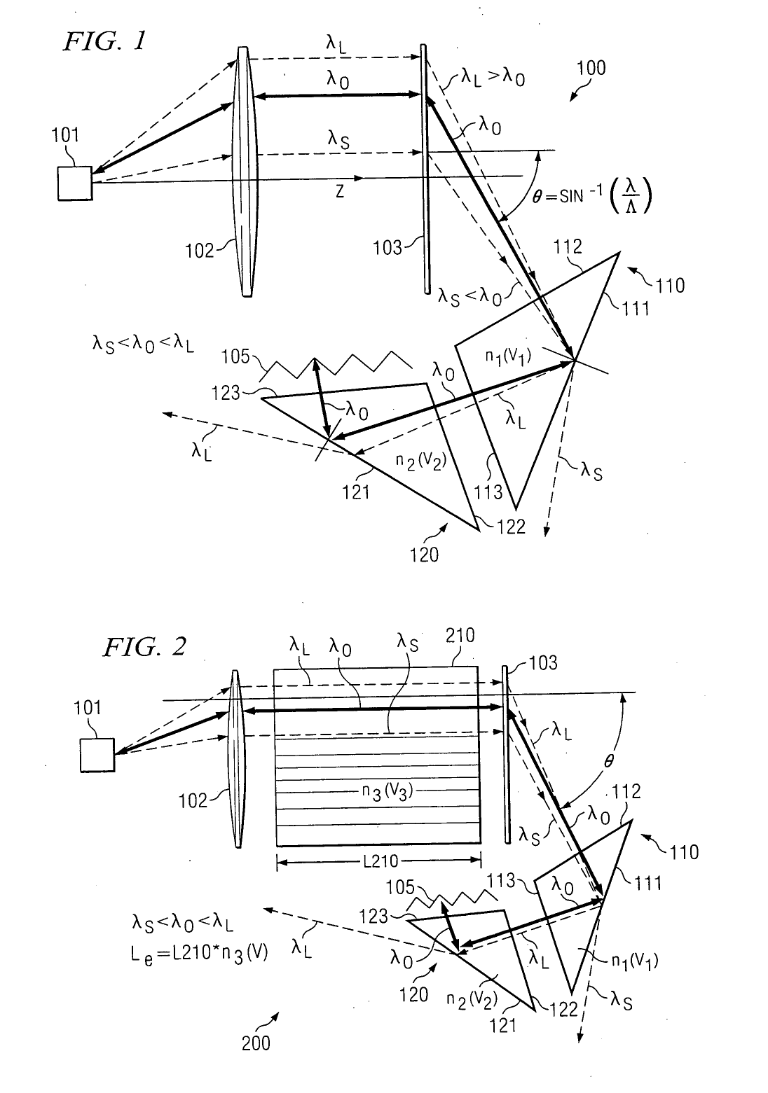

As illustrated in FIG. 1, external cavity laser 100 (see for example Tunable Lasers Handbook, F. J. Duarte, ed., Academic Press, 1995; Chapter 8, Tunable External-Cavity Semiconductor Lasers, pp. 349-413) includes optical gain medium 101; collimating element 102, for example a focusing lens; dispersing element 103, e.g., a diffraction grating; two variable index electro-optic elements 110, 120 comprising, e.g., liquid crystals (see for example Handbook of Optics, M. Bass, ed., McGraw-Hill, 1995; Chapter 14, Liquid Crystals, pp. 14.1-14.23); and retro-reflector 105. One purpose of an external cavity is advantageously returning to the optical gain medium light of a desired resonant wavelength λ₀, which after reflection by a back facet of the optical gain medium, is identical in wavelength and phase with light emitted by the optical gain medium. This property allows the light returned from the external cavity to control the wavelength and phase (mode) of laser resonance. As used herein, light is defined to be electromagnetic energy of any wavelength from 1 nanometer (nm) to 1 millimeter, particularly including wavelengths in the visible, infrared, and near ultraviolet portions of the electromagnetic spectrum.

Light emitted from optical gain medium 101 is collected and collimated by collimating element 102, which may be a reflecting paraboloid, a refractive lens, or a diffractive (e.g., Fresnel) element. The diameter of collimating element 102 should be large enough to collect over 90 percent of the optical flux (power) emitted by optical gain medium 101. The collimated light propagates along the z direction (indicated by the labeled directional arrow in FIG. 1) and is incident on dispersing element 103, for example, a linear transmission diffraction grating. It is convenient but not necessary to orient the plane of the diffraction grating orthogonal to the z-axis propagation direction. Light transmitted through dispersing element 103 is diffracted predominantly into a single diffraction order, without loss of generality the +1 order. This is accomplished using a “blazed” grating, well known in the art. The cross-sectional profile of such a “blazed” grating is sawtooth shaped. If this shape is appropriately sized, the diffraction efficiency into the +1 order is maximized (80-100 percent). The direction of the diffracted light is given by the grating equation:
sin θ=λ/Λ,
where λ is the wavelength of light, Λ is the grating pitch, and θ is the angle between the diffracted propagation direction and the direction normal to the grating surface (z axis). In the example depicted in FIG. 1, the grating rulings run in a direction perpendicular to the plane of the figures. In accordance with the grating equation above, diffraction angle θ varies according to the wavelength of light diffracted. Wavelengths longer than λ₀, for example λ_{L}, are diffracted through larger angles than wavelengths shorter than λ₀, for example λ_{S}. Diffracted light of all wavelengths is incident on first optical interface 112 of first variable index electro-optic element 110 and is refracted into the interior of first variable index electro-optic element 110. It is convenient but not necessary to shape and orient first variable index electro-optic element 110 so that light of desired resonant wavelength λ₀ is normally incident onto first optical interface 112.

After traversing the interior of variable index electro-optic element 110, light of all emitted wavelengths is next incident on second optical interface 111. Importantly, variable index electro-optic element 110 is shaped and oriented such that light of desired resonant wavelength λ₀ is incident on second optical interface 111 at an angle near the critical angle θ_{1cr} for total internal reflection (TIR). The critical angle is defined by the relation: n₁(V) sin θ_{1cr}=1, where n₁(V) is the electrically-dependent refractive index of first variable index electro-optic element 110 adjacent second optical interface 111 and θ_{1cr} is measured relative to the normal to second optical interface 111, in accordance with convention (see, for example, E. Hecht, “Optics,” Addison-Wesley, 1974, pp. 97-98).

Electro-optic materials belong to a class of optical materials whose refractive index can be varied by the application of a control voltage. Accordingly, refractive index n₁(V₁) within variable index electro-optic element 110 can be varied with the application of control voltage V₁. Changing control voltage V₁ applied within variable index electro-optic element 110 likewise changes critical angle θ_{1cr}. Thus, varying applied voltage V₁ controls the boundary (in wavelength terms) between the range of wavelengths of light incident on optical interface 111 totally internally reflected into and the range of wavelengths partially refracted out of variable index electro-optic element 110, as described below in more detail.

If the desired resonant wavelength of laser 100 is equal to λ₀, optical gain medium 101 is capable of emitting light in a range of wavelengths including wavelengths longer (λ_{L} in FIG. 1) and shorter (λ_{S} in FIG. 1) than λ₀. Light of wavelength λ_{L} longer than λ₀ is diffracted by dispersing element 103 through angles θ larger than diffracted angles for light of wavelength λ₀. As a result, light of wavelength λ_{L} longer than λ₀ is refracted into the interior of first variable index electro-optic element 110 at optical interface 112 and is incident on optical interface 111 at a larger angle relative to the normal to optical interface 111 than is light with wavelength equal to λ₀. Light of wavelength λ_{S} shorter thanλ₀ is conversely diffracted at dispersing element 103 through angles θ smaller than diffracted angles for light of wavelength equal to λ₀. As a result, light of wavelength λ_{S} shorter than λ₀ is refracted into the interior of first variable index electro-optic element 110 at optical interface 112 and is accordingly incident on optical interface 111 at a smaller angle relative to the normal to optical interface 111 than is light of wavelength equal to λ₀. By adjusting critical angle θ_{1cr} at optical interface 111 via the application of control voltage V₁, only light of wavelength λ_{L}, longer than or equal to λ₀, is totally internally reflected at optical interface 111. Light of shorter wavelength λ_{S} relative to λ₀ refracts partially through optical interface 111 and thereby undergoes selective partial segregation from light of desired wavelength λ₀ and of longer wavelengths in laser cavity 100. Optical interface 111 alone accordingly behaves as a long wavelength pass filter.

The light totally internally reflected from optical interface 111 with wavelength λ_{L} greater than or equal to λ₀ propagates out through optical interface 113 of first variable index electro-optic element 110, is incident on optical interface 122 and is refracted into the interior of second variable index electro-optic element 120. Importantly, second variable index electro-optic element 120 is shaped and oriented such that critical angle θ_{2cr} for TIR occurs near the angle of incidence for light of wavelength λ₀ at second optical interface 121. Additionally, at optical interface 121, unlike at optical interface 111, light of wavelength λ_{L} longer than λ₀ is incident at smaller angles relative the normal to optical interface 121 than light of wavelength λ₀. Critical angle θ_{2cr} such that n₂(V₂) sin θ_{2cr}=1 is adjusted via the application of control voltage V₂, such that only light with wavelength λ_{S} shorter or equal to λ₀ is TIR reflected at optical interface 121. All longer wavelengths λ_{L} are partially refracted through optical interface 121 and thus are selectively partially segregated from desired wavelength λ₀ and from shorter wavelengths in external cavity laser 100. Optical interface 121 alone accordingly behaves as a short wavelength pass filter.

Accordingly, only light of tunable wavelength λ₀ propagates efficiently within external cavity laser 100 relative to longer and shorter wavelengths λ_{L} and λ_{S}. Optical interfaces 111 and 121 together behave as an electrically tunable bandpass wavelength filter. Relatively efficiently propagating light of wavelengthλ₀ emerges through optical interface 123, is reflected from retro-reflector 105, and effectively retraces its path through cavity 100 back to gain medium 101. After retro-reflection, once again wavelengths λ_{L} and λ_{S} longer and shorter than λ₀ are partially segregated from tunably selected wavelengthλ₀ at respective optical interfaces 111 and 121 because of refraction and reflection near voltage-tunable critical angles θ_{1cr} and θ_{2cr}. In some embodiments, retro-reflector 105 can be integrally combined with optical interface 123 of electro-optic element 120. Alternatively, any of a wide variety of optical feedback elements, for example, prisms, TIR reflectors, planar mirrors, curved mirrors, and fiber Bragg gratings, may be used in place of retro-reflector 105.

It is convenient although not necessary for first and second variable index electro-optic elements 110 and 120 to be shaped and oriented such that light of desired resonant wavelength λ₀ is normally incident on optical interfaces 113 and 122. Alternatively, first and second variable index electro-optic elements 110 and 120 can be combined into a single electro-optic element shaped and oriented such that optical interfaces 113 and 122 are eliminated and such that light of desired resonant wavelength λ₀ is incident on each of optical interfaces 111 and 121 at angles near the critical angles for TIR. For convenience, first and second variable index electro-optic elements 110 and 120 can be prism-shaped. Alternatively, they can be configured in other two-dimensional or complex three-dimensional shapes with three-dimensional light propagation paths.

Accordingly, without loss of generality, the application of variable control voltages V₁ and V₂ to respective first and second variable index electro-optic elements 110 and 120 selectably tunes critical angles θ_{1cr} and θ_{2cr} at respective optical interfaces 111 and 121. This causes optical interfaces 111 and 121 together to behave as an electrically tunable bandpass wavelength filter, which tunably selects light at or adjacent a unique resonant wavelength λ₀ to propagate with higher efficiency within external cavity laser 100 relative to longer and shorter wavelengths λ_{L} and λ_{S}. By varying control voltages V₁ and V₂, resonant wavelength λ₀ within external cavity laser 100 is changed or tuned.

Even though discrimination against wavelengths λ_{L} and λ_{S} longer and shorter than λ₀ near voltage-selectable critical angles θ_{1cr} and θ_{2cr} is a gradual function of wavelength, it is typically sufficient to ensure single-mode oscillation in external cavity laser 100. Numerical analysis using the well-known Fresnel equations shows that, for an example of center wavelength λ₀=1.59 μm, no more than 10 modes propagate in the top 10 percent of the cavity efficiency curve. Experience has shown further that, if ten or fewer modes propagate in the top 10 percent of the cavity efficiency curve, then nonlinear mode competition for the population inversion in optical gain medium 101 will limit actual oscillation within the cavity to a single dominant mode only. Accordingly, the method described above provides tuning of external cavity laser to desired resonant wavelength λ₀ through application of variable control voltage to variable index electro-optic elements 110, 120, without requiring mechanical motion.

FIG. 2 depicts external cavity laser 200, in a further embodiment of the present invention, incorporating additional variable index electro-optic element 210, which is used to adjust the effective optical path length of light propagating within the external cavity laser. Additional variable index electro-optic element 210 can be located anywhere within external cavity laser 200, provided that the propagation path of desired resonant wavelength λ₀ passes through it. Advantageously, additional variable index electro-optic element 210 is located in the collimated beam space between collimating element 102 and dispersing element 103, where the propagation paths of emitted light of all wavelengths are parallel with one another. To maximize the range of adjustment of optical path length, additional variable index electro-optic element 210 can be configured to occupy a maximum length within the collimated beam space.

Additional variable index electro-optic element 210 enables optical path length tuning by varying refractive index n₃(V₃) of additional variable index electro-optic element 210 via application of variable control voltage V₃, and hence changing the optical path length (physical path length L210 multiplied by refractive index n₃(V₃)) of light propagating within additional variable index electro-optic element 210. By placing additional variable index electro-optic element 210 within the cavity of external cavity laser 200, the optical path length of the cavity can be tuned for light propagating within the cavity. The mode number n(m) associated with resonant light within the cavity is directly related to resonant wavelength and cavity path length through the expression n(m)=(cavity optical path length)/(wavelength). For example, the mode number n(m) of resonant wavelength λ₀ within external cavity laser 200 can be tuned electrically by varying control voltage V₃ applied to additional variable index electro-optic element 210. Thus, resonant wavelength λ₀ within external cavity laser 200 can be tuned electrically via applying variable control voltages V₁ and V₂ to variable index electro-optic elements 110 and 120, for example, while keeping mode number n(m) constant via tunable control voltage V₃ applied to additional variable index electro-optic element 210, without requiring mechanical motion. Alternatively, mode number n(m) can be tuned independently by varying control voltage V₃, regardless of any ability to provide wavelength tuning by applying variable control voltages V₁ and V₂.

Alternatively, the effectively optical path length within the cavity of external cavity laser 200 can be tuned by translating retro-reflector 105 parallel to the optical path of light of resonant wavelength λ₀, i.e., perpendicular to the line formed by the locus of all bottom or top apex points of the sawtooth retro-reflector profile. This translation does not affect the directionality of the resonant light, but it changes the cavity optical path length, causing tuning of the resonant mode number n(m). Although this technique has the disadvantage of requiring mechanical motion, it can, for example, be used to provide coarse mechanical mode number tuning optionally in conjunction with applying variable control voltage V₃ to provide fine electrical mode number tuning.

Wavelength tuning in embodiments of the invention is achieved by application of a control voltage without requiring mechanical motion. As a result, the adverse effects associated with mechanical tuning, such as thermal issues, non-repeatable motion, and backlash, are avoided. Also, an electrically-controlled external cavity laser does not require a bulky motor for mechanical tuning and is, hence, more easily miniaturized. Further, wavelength and mode number can simultaneously be controlled electrically. Control voltages, for example V₁, V₂, V₃, applied individually to variable index electro-optic element 110, 120, and/or 210 can be equal or unequal in value to one another, and can be individually or cooperatively controlled conventionally, programmably and/or through feedback signals derived from photodetectors or other appropriate sensors (not shown in FIG. 2).

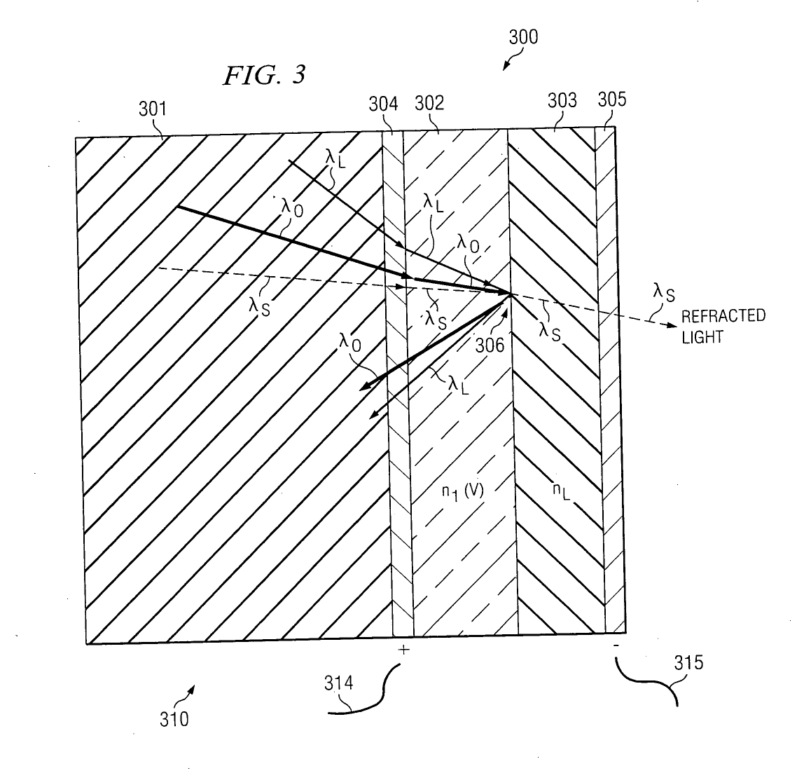

FIG. 3 depicts wavelength selective total internal optical reflection occurring complementarily with partial refraction of a light beam in layered structure 300 at an interface between a liquid crystal layer and a lower index optical medium. Layered structure 300 can be regarded as a more detailed representation of an embodiment of optical interface 111 or 121 of respective variable index electro-optic element 110 or 120 depicted in FIG. 1. Liquid crystal layer 302 having a voltage-dependent refractive index, for example n₁(V₁), is situated between outer dielectric layer 303 of lower refractive index n_{L} and substantially transparent dielectric layer 301, which can for example be optical glass or optical grade polymer. Dielectric layer 301 has an arbitrary refractive index, which can for example be equal to the refractive index n_{L} of dielectric layer 303. Layered structure 300 depicted in FIG. 3 is advantageous, because it provides containment between two solid dielectric layers 301, 303 for a layer 302 of liquid crystal material.

Transparent electrically-conducting film layers 304 and 305 connected through conductors 314 and 315 to a variable voltage source (not shown) apply a variable voltage across liquid crystal layer 302. The voltage electrically tunes the refractive index n₁(V₁) of liquid crystal layer 302. This in turn provides a tunable critical angle θ_{1cr} for TIR at optical interface 306 between liquid crystal layer 302 and outer low-index dielectric layer 303, where θ_{1cr} satisfies the relation n₁(V₁) sin θ_{1cr}=n_{L}. As depicted in FIG. 3, the voltage applied by the variable voltage source through conductors 314 and 315 electrically tunes the critical angle θ_{1cr}, so that light of desired wavelength λ₀ and all longer wavelengths λ_{L} incident from dielectric layer 301 through liquid crystal layer 302 is totally internally reflected at optical interface 306, whereas light of shorter wavelengths λ_{S} partially refracted at optical interface 306 into outer dielectric layer 303 and exits from the external cavity through conducting film 305 into an external medium, for example air 310. Accordingly, optical interface 306 behaves as a long wavelength pass filter, similar to optical interface 111 of FIG. 1. Conversely, a similarly layered structure may be oriented such that an optical interface behaves as a short wavelength pass filter, similar to optical interface 121 of FIG. 1. In alternative embodiments, layer 302 of liquid crystal material can be replaced by a different electro-optic material.

Similar to combining first and second variable index electro-optic elements 110 and 120 into a single variable index electro-optic element as described in connection with FIG. 1, in some embodiments both long and short wavelength pass filter implementations of layered structure 300 can be contained physically within a single variable index electro-optic element. In such combined implementations, it is convenient although not necessary to apply equal control voltages to both layered structures.

Refractive index n₁(V₁) of liquid crystal layer 302 is electrically tunable over a range of approximately 1.5 to 1.7. Optical-grade dielectric materials suitable for dielectric layer 303 have refractive indices smaller than the minimum index in the range for the liquid crystal material. Candidates include, for example, silicon dioxide (SiO₂) and lithium fluoride (LiF), having respective refractive indices of 1.45 and 1.38. Transparent conducting film layers 304 and 305 can be made, for example, of indium tin oxide (ITO), which is 50% transparent at a wavelength of 1.5 micrometers (μm) and 90 percent transparent at visible and near infrared (<1.0 μm) wavelengths. Layered structure 300 is configured so that transparent conducting film layers 304, 305 are spaced away from TIR interface 306 and therefore produce no adverse effect on the optical properties of the interface. Refracted light escapes from the external cavity of the laser if outer conducting film layer 305 has a rough surface that causes diffuse reflection and scattering. Refracted light likewise escapes if outer conducting film layer 305 is absorbing, or if it is specularly reflecting but non-parallel to the plane of optical interface 306, and thus deflects incident light either in or out of the optical plane of the external cavity.

In addition to liquid crystals, the embodiments can employ other electro-optic materials, for example lithium niobate or other electro-optic crystals, that provide a substantially transparent optical medium across the wavelength range of interest and have electrically-dependent refractive indices. Liquid crystals exhibit a greater coefficient of refractive index change relative to control voltage than do other materials, such as lithium niobate, but have the drawback of scattering light. For example, light scattering through a thickness greater than or equal to 5 mm of liquid crystal is observed to degrade light propagation efficiency by at least 50 percent relative to the same path length through a non-scattering medium. Hence, liquid crystals are particularly advantageous in thin layers. Again in accordance with numerical analysis results, wavelength discrimination in layered structure 300 in an external cavity laser is expected to be slightly inferior to that described above in connection with long optical-path, low-scatter media in FIG. 1. Practically, however, in layered structure 300, the thickness of liquid crystal layer 302 can be limited easily to less than 5 mm, and in some embodiments as thin as a few micrometers (μm), thus minimizing the adverse effect of light scattering. Additionally, confinement of the liquid crystal layer provides advantages relating to manufacturability and reliability. Conversely, for applications such as that described in connection with FIG. 2, where a long optical path through additional electro-optic element 210 is desirable, lithium niobate or a similar low-scatter material may be employed.

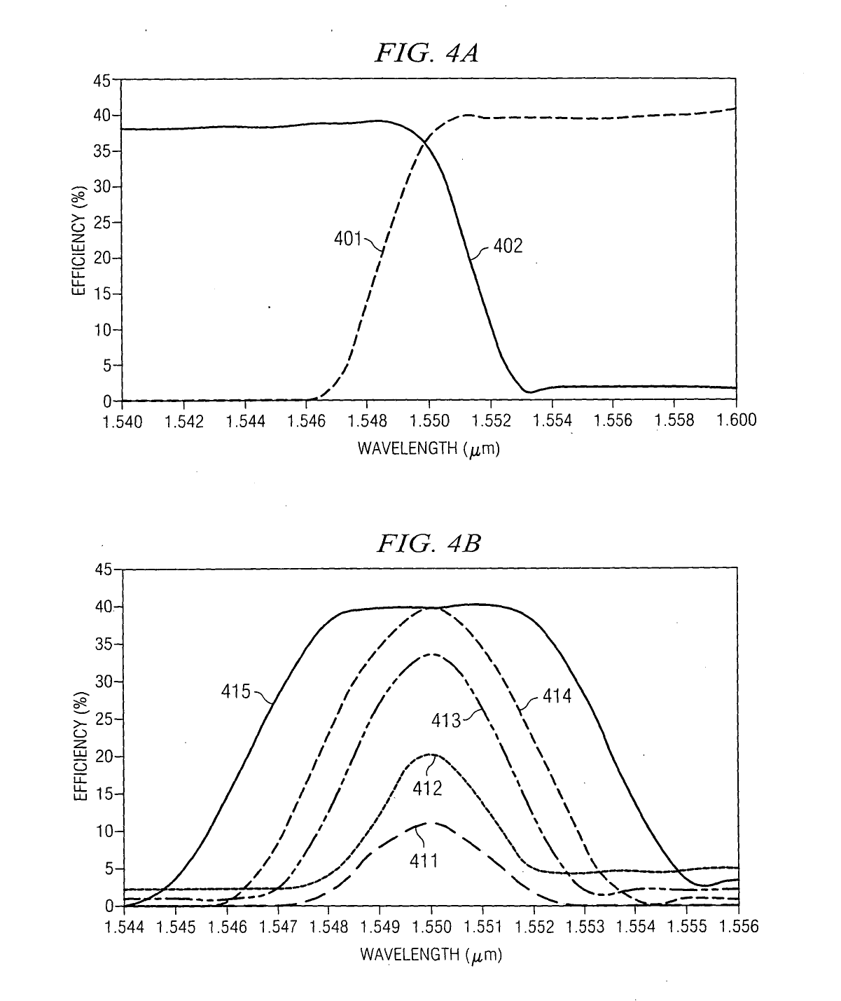

FIG. 4A is a graph showing simulated long wavelength pass and short wavelength pass filter characteristics of a liquid crystal embodiment. The results are not qualitatively altered for other low index material/liquid crystal optical interfaces. Curve 401 represents the long wavelength pass effect of a first liquid crystal-based element similar to first variable index electro-optic element 110 depicted in FIG. 1. In the simulation, the liquid crystal index of refraction is set to provide a critical angle such that light of wavelengths longer than approximately 1.550 μm is total internally reflected. Accordingly, first variable index electro-optic element 110 operating alone acts as a long wavelength pass filter. Curve 402, on the other hand, represents the optical performance of a second liquid crystal-based element similar to second variable index electro-optic element 120 depicted in FIG. 1. In second variable index electro-optic element 120, light of wavelength shorter than about 1.550 μm undergoes total internal reflection. Accordingly, second variable index electro-optic element 120 operating alone acts as a short wavelength pass filter.

FIG. 4B is a graph showing the simulated behavior of a long wavelength pass and a short wavelength pass filter combined to provide a bandpass wavelength filter centered on 1.550 μm. In this simulation, a collimating element of focal length 2.5 mm and a dispersion angle of 60 degrees are chosen. Both liquid crystal-based elements are chosen to have equal refractive indices, which are varied identically over a range from 1.6005 for curve 411 to 1.605 for curve 415. For the geometry chosen, the bandpass center wavelength does not change, but the width (FWHM) increases with increasing refractive index from 2.7 nm for curve 411 to 7 nm for curve 415. As the bandpass width increases, the central portion of the bandpass becomes flat (A range of wavelengths is passed.). For the individual curves labeled in FIG. 4B, the respective refractive indices and corresponding bandpass widths (FWHM) are:

| | | |
|---|---|---|
| Curve 411: | n = 1.6005 | FWHM = 2.7 nm; |
| Curve 412: | n = 1.601 | FWHM = 3.0 nm; |
| Curve 413: | n = 1.602 | FWHM = 3.4 nm; |
| Curve 414: | n = 1.603 | FWHM = 4.5 nm; |
| Curve 415: | n = 1.605 | FWHM = 7 nm |

More generally, it is possible to move the center wavelength of the pass band to shorter or longer wavelengths by varying the refractive indices of the two liquid crystal-based elements unequally. This could be useful in external cavity laser tuning and in other situations where a dynamic bandpass filter is desired, for example, in receivers where the certain incoming wavelengths are selected, or to select wavelengths to be re-routed in an optical switch or in an add-drop optical multiplexer. Likewise, individual long wavelength pass and short wavelength pass filters represented by curves 401 and 402 can be useful to select wavelengths to be re-routed in a switch or in an add-drop optical multiplexer.

A range of embodiments alternative to that depicted in FIG. 3 provides for the application of control voltage and/or application of an electrical field along an axis oriented at any angle relative to the plane of incidence at the TIR interface of the liquid crystal layer, as desired for a particular application. For example, an applied voltage may cause current to flow in a ring-shaped electrode, giving rise to a current-dependent magnetic field that controls the refractive index by aligning the molecules of the liquid crystal-based element.

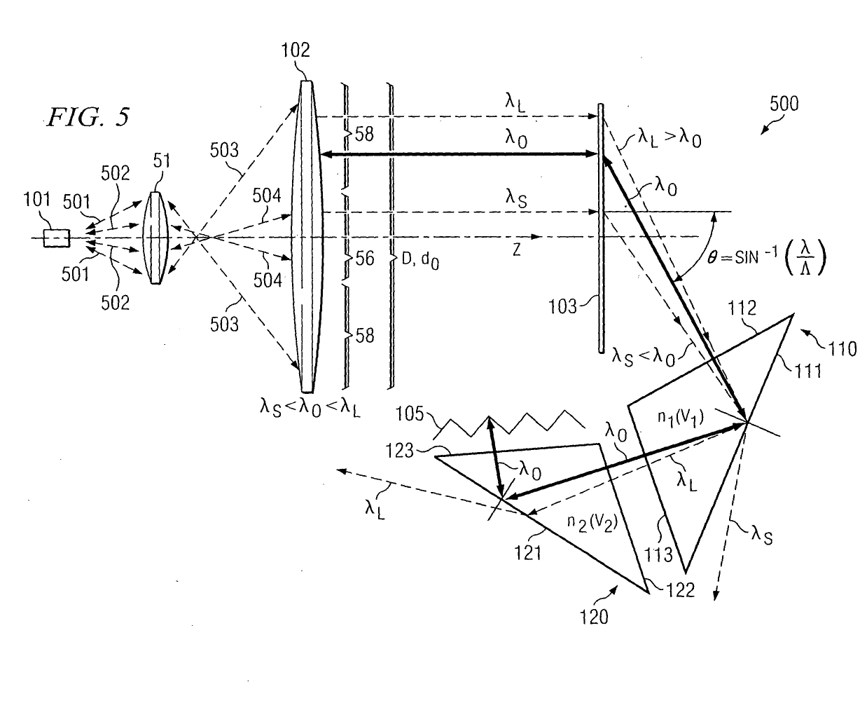

FIG. 5 depicts external cavity laser 500 similar to external cavity laser 100, 200 shown in FIGS. 1-2, but including optical relay element 51 between optical gain medium 101 and collimating element 102. A somewhat analogous optical relay element is described in concurrently filed, co-pending and commonly assigned U.S. patent application Ser. No. ______ [Attorney Docket 10030130-1], the disclosure of which has been incorporated herein by reference. Optical gain medium 101 emits light beam 501, 502, which typically has insufficient beam divergence to fill the overall aperture diameter D of collimating element 102, but instead fills only a smaller diameter aperture, for example central radial portion 56 of collimating element 102. The beam collimated by collimating element 102 consequently underfills the aperture of dispersing element 103, which may impair the performance of dispersed wavelengths of the beam diffracted by dispersing element 103. Optical relay element 51 transforms light beam 501, 502 of low beam divergence into light beam 503, 504 of larger beam divergence, which fills overall aperture diameter D of collimating element 102, including peripheral radial portion 58. Optical relay element 51 can be, for example, a convex refractive relay lens, an off-axis concave mirror, or another optical element capable of transforming the beam divergence of light beam 501, 502.

Furthermore, external cavity laser 500 may optionally include additional variable index electro-optic element 210 to provide mode number tuning by electrically varying refractive index n₃), as described in connection with FIG. 2 above.

1. An optical system, comprising:
a dispersing element operable to disperse a light beam at a wavelength-dependent angle; and
a variable index electro-optic device positioned in the path of said light beam, said variable index electro-optic device comprising a variable index electro-optic element having an electrically-variable refractive index, such that said variable index electro-optic element is operable to perform wavelength-selective filtering of said light beam, dependent on the value of an applied control voltage.

2. The optical system of claim 1 wherein said variable index electro-optic element is operable to perform said wavelength-selective filtering function selected from the group consisting of short wavelength pass filtering, long wavelength pass filtering, and bandpass wavelength filtering.

3. The optical system of claim 1 wherein said variable index electro-optic element is operable to perform said wavelength selective filtering by varying the critical angle for total internal optical reflection (TIR) at an interface of said electro-optic element in response to said applied control voltage.

4. The optical system of claim 3 wherein said variable index electro-optic device comprises a first said electro-optic element and a second said electro-optic element, through which said light beam propagates sequentially;
said first electro-optic element operable tunably to partially segregate light of undesired wavelengths shorter than a desired wavelength from said light of said desired wavelength at a TIR interface, dependent on the value of a first applied control voltage; and
said second electro-optic element operable tunably to partially segregate light of undesired wavelengths longer than said desired wavelength from said light of said desired wavelength at a TIR interface, dependent on the value of a second applied control voltage.

5. The optical system of claim 1 wherein said variable index electro-optic device comprises an electro-optic material.

6. The optical system of claim 5 wherein said variable index electro-optic device comprises a liquid crystal material.

7. The optical system of claim 6 wherein said variable index electro-optic element comprises a layered structure, wherein a layer of liquid crystal material is disposed between layers of dielectric material.

8. The optical system of claim 1 wherein:
said system constitutes part of an external cavity laser (ECL) operable to generate a light beam at a single tunable wavelength dependent on said applied control voltage; and
said ECL additionally comprises:
an optical feedback element; and
an optical gain medium operable to generate said light beam at a wavelength within a range of wavelengths by stimulated emission and disposed to direct said light beam toward said dispersing element and said optical feedback element.

9. The optical system of claim 8 wherein said ECL is operable to tune said tunable wavelength by changing the effective optical path length in said variable index electro-optic element, dependent on said value of said applied control voltage, such that the mode number of said light beam generated in said ECL is electrically tuned.

10. The optical system of claim 9 wherein said variable index electro-optic element is disposed between said gain medium and said dispersing element.

11. The optical system of claim 8 wherein said ECL is operable to generate a light beam at said single tunable wavelength by varying the critical angle for total internal optical reflection (TIR) at an interface of said variable index electro-optic element in response to said value of said applied control voltage.

12. The optical system of claim 8 wherein said optical feedback element comprises a retro-reflector and wherein said variable index electro-optic element is disposed within said ECL between said dispersing element and said retro-reflector.

13. The optical system of claim 8 wherein said variable index electro-optic device comprises a first said electro-optic element and a second said electro-optic element through which said light beam propagates sequentially;
said first electro-optic element operable to perform said wavelength selective filtering by varying the critical angle for TIR in response to a first applied control voltage; and
said second electro-optic element operable to perform said selective tuning of the mode number of said generated light beam by changing the effective optical path length in said second electro-optic element in response to a second applied control voltage.

14. The optical system of claim 8 wherein said ECL further comprises a collimating element disposed between said optical gain medium and said dispersing element.

15. The optical system of claim 14 wherein said ECL further comprises an optical relay element disposed between said optical gain medium and said collimating element.

16. A method of tunable wavelength filtering without mechanical motion, said method comprising:
receiving a light beam of wavelength within a range of wavelengths;
dispersing said light beam at a wavelength-dependent angle;
propagating said light beam through an electro-optic device comprising an electrically-variable refractive index electro-optic element; and
applying a control voltage to said electro-optic device to cause tunable wavelength filtering dependent on said control voltage.

17. The method of claim 16 wherein applying said control voltage causes tunable wavelength filtering selected from the group consisting of short wavelength pass filtering, long wavelength pass filtering, and bandpass wavelength filtering.

18. The method of claim 16 further comprising:
varying the critical angle for total internal reflection (TIR) at an interface of said variable index electro-optic element in response to applying said control voltage;
totally internally reflecting light of desired wavelength in said light beam at said interface in response to varying said critical angle; and
partially segregating light of undesired wavelengths in said light beam from said light of said desired wavelength at said interface in response to varying said critical angle.

19. The method of claim 18 wherein said electro-optic device comprises a first variable index electro-optic element and a second variable index electro-optic element, and said tunable wavelength filtering comprises:
applying a first control voltage to said first variable index electro-optic element;
applying a second control voltage to said second variable index electro-optic element;
propagating said light beam sequentially through said first variable index electro-optic element and said second variable index electro-optic element;
tunably partially segregating light of undesired wavelengths shorter than said desired wavelength at a TIR interface of said first variable index electro-optic element in response to applying said first control voltage; and
tunably partially segregating light of undesired wavelengths longer than said desired wavelength at a TIR interface of said second variable index electro-optic element in response to applying said second control voltage.

20. The method of claim 19 wherein said first control voltages and said second control voltage have values independent of one another.

21. The method of claim 16 wherein said tunable wavelength filtering, said receiving, said dispersing, and said propagating occur within an external cavity laser (ECL), said ECL comprising an optical gain medium, a dispersing element, an optical feedback element, and a variable index electro-optic element.

22. The method of claim 21 wherein said optical feedback element comprises a retro-reflector and wherein said light beam is retro-reflected within said ECL through said variable index electro-optic element and said dispersing element to said gain medium.

23. The method of claim 21 further comprising:
varying the effective optical path length through said variable index electro-optic element in response to a variable control voltage applied to said variable index electro-optic element; and
causing said light beam to oscillate within said ECL at a desired tunable wavelength in response to said varying optical path length, such that the mode number of said oscillating light beam within said ECL is electrically tuned.

24. The method of claim 21 further comprising:
varying the critical angle for TIR at an interface of said variable index electro-optic element in response to applying said control voltage;
totally internally reflecting light of desired wavelength in said light beam at said interface in response to varying said critical angle;
partially segregating light of undesired wavelengths in said light beam from said light of said desired wavelength at said interface in response to varying said critical angle; and
causing said light beam within said ECL to oscillate at a desired tunable wavelength in response to said tunable wavelength filtering of said light beam.

25. The method of claim 16 wherein said variable index electro-optic element comprises a layer of liquid crystal material disposed between layers of dielectric material.

26. The method of claim 16 wherein said control voltage has a value determined in response to a feedback control signal.

27. The method of claim 16 wherein said receiving said light beam comprises:
emitting said light beam; and
collimating said emitted light beam prior to said dispersing.

28. The method of claim 27 further comprising transforming the beam divergence of said emitted light beam from a low divergence value to a higher divergence value prior to said collimating.
